(19) United States
(12) Patent Application Publication
(10) Pub. No.: US 2012/0254351 A1
(43) Pub. Date: Oct. 4, 2012

(54) Method and system for publishing digital content for passive consumption on mobile and portable devices

(75) Inventors: Venkata S. Tanikella, San Jose, CA (US); Ramarao Babbellapati, Issaquah, WA (US)

(73) Assignees: Mr. Ramarao Babbellapati, San Jose, CA (US); Mr. Venkat S. Tanikella, San Jose, CA (US)

(21) Appl. No.: 13/345,666

(22) Filed: Jan. 6, 2012

Related U.S. Application Data
(60) Provisional application No. 61/430,173, filed on Jan. 6, 2011.

(51) Int. Cl. G06F 15/16

(52) U.S. Cl. 709/217

(57) ABSTRACT

Web content is predominantly text and graphics oriented needing visual attention. The majority of web sites publish their content catering to such interactive consumption model. As an alternative to the interactive consumption, one can think of a minimally interactive passive mode of consumption where the user can listen to text spoken as audio. The proposed invention—is about multi-tier content adaptation and publishing architecture transforming existing content into a form amenable to minimally interactive usage and wider reach. The adaption of content would benefit both the publishers and the consumers. The invention outlines a multi-tier framework that adapts the content through various optional building blocks. The multiple tiers include, content adaption, augmentation and transformation into passive and minimally interactive audio form through a plurality of techniques. A consumer friendly content presentation enables the client to access this information in a seamless manner.

### BACKGROUND OF THE INVENTION

The vastness of web is quite evident. The web content is ever-changing with more content being added every second. On the consumer front, with the web impacting almost every facet of life, the desire to consume more content is also going up. Advances in communication technology, mobile and portable smart devices enable the user to consume information on the move. Keeping up with all this essential and not so essential information is a daunting and time consuming task for producers and consumers.

Web content is predominantly text and graphics oriented needing visual attention. The majority of web sites publish their content catering to such interactive consumption model. As an alternative to the interactive consumption, one can think of a minimally interactive passive mode of consumption where the user can listen to text spoken as audio. Such a form of consumption comes handy in several day-day situations where listening to the content itself is secondary to another primary task. Examples include listening while: driving, exercising, leisure walks, cooking etc. The proliferation of portable devices makes such a passive consumption all the more easier and handy. However, the amount of content available for such passive consumption is very limited.

To summarize, the problem is two sided. On one side publishers have tuned content for a highly interactive model that is not suitable for passive consumption. On the other side is the user community, with an ever increasing need to catch up with the information explosion in new smart and time efficient manner.

The present invention is in the field of digital content adaptation. More particularly the invention is about multi-tier content adaptation and publishing architecture transforming existing content into a form amenable to minimally interactive usage and wider reach. The adaption of content would benefit both the publishers and the consumers.

Podcasts address this issue to some extent. However, podcast publishing incurs high production, storage costs and high bandwidth over the network. Today podcasts lack widespread adaptability for the same reasons.

### SUMMARY OF THE INVENTION

The current invention relates to a content adaptation and distribution system with the following features:
A publisher friendly model enabling wider audience reach to publisher's content with support for subscription, ad-revenues, copyrights preservation and a feedback mechanism.
Content adaptation—processing the original published content into a form amenable for the end-consumption by applying a plurality of techniques comprising of: categorization summarization, translation, annotation, markup, tagging.
Content Augmentation—augmenting the content, in a hierarchical fashion at multiple stages, with a plurality of auxiliary content like: promotions, advertisements (text, textual advertisements converted to audio as well as other multi-media advertisements) and related content.
Content transformation—transforming the main and auxiliary content into passive & minimally interactive audio form.
Consumer friendly content presentation—Enables client device to consume the adapted, augmented and transformed content from a variety of sources in a seamless manner.

### BRIEF DESCRIPTION OF DRAWINGS

FIG. 1 is the high level system architecture diagram of the present invention.

FIG. 2 is the Content Routing and Directory Server—CoRDS

FIG. 3 is the Text to Speech Module (TSM)

FIG. 4 is the Content Adaptation & Transformation Server CATS

FIG. 5 is the Content Consuming Client Device (CCCD) and Client Device Agent (CDA)

FIG. 6 is an alternative “application service provider” deployment scenario

### DETAILED DESCRIPTION OF THE INVENTION

### Overall Architecture & Data Flow

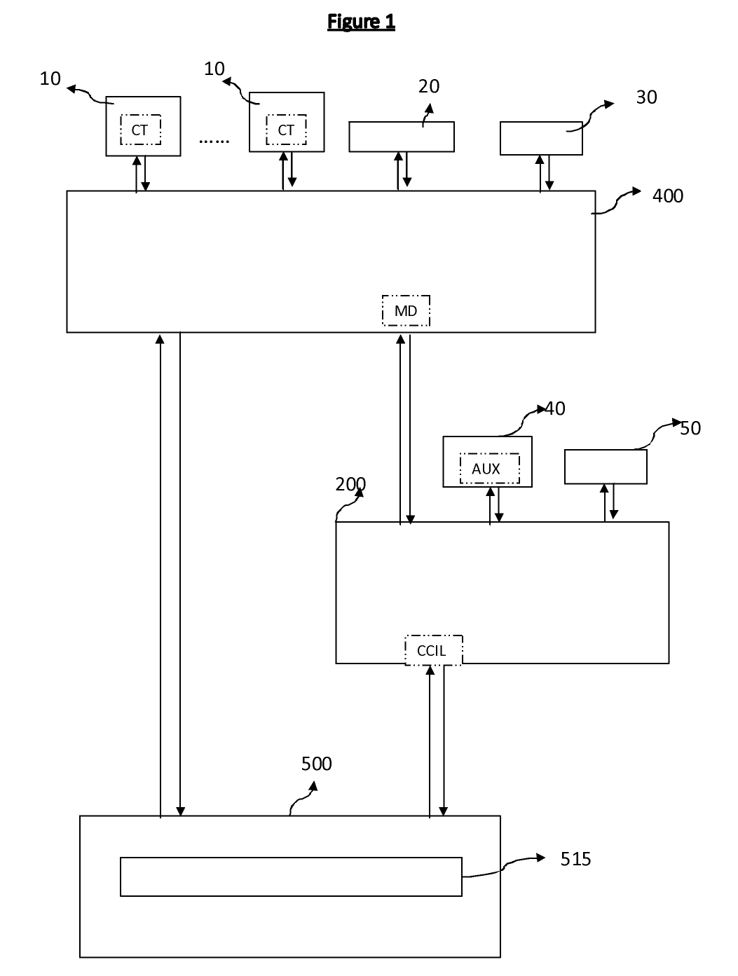

FIG. 1 shows the high level system architecture to adapt and publish existing digital content for passive consumption on mobile, portable and other devices. The system consists of one or more content sources 10 from one or more publishers, and a Content Adaptation and Transformation Server(CATS) 400 associated with each publisher, a Content Routing and Directory Server (CoRDS) 200 and Content Consuming Client Devices (CCCD) 500. The CCCD 500 has a resident Client Device Agent (CDA) 515.

Illustrated further in FIG. 1 the CATS 400 is responsible for adapting the content, serving the meta data about the adapted content to CoRDS 200 and serving adapted content to the end clients (CCCD) 500. The CoRDS 200 maintains the meta-data of the adapted content. It acts as a directory server that tracks the relevancy of the adapted content from the client's point of view, as well as its location. The resident CDA 515 on CCCD 500 initiates a request for adapted content of a certain categories to the CoRDS 200. The capabilities and preferences of the client device (CCCD) 500 are tracked by the CoRDS 200 system. The CoRDS 200 compiles relevant content based on the consumption history, preferences set by the client and a host of other access criteria and responds with a Compiled Content Information List (CCIL) for the requested categories of content. Using the CCIL, the CDA 515 makes subsequent requests to CATS 400 to fetch the actual adapted content.

As illustrated further in FIG. 1, a publisher's content source 10 is the provider of the content that needs to be transformed for passive consumption. The content source 10 can be a website or a blogging site and any other form of information with a well defined interface offering content. The content CT fetched from the source could be any textual content such as a blog, a news article, a story, textual advertisements or any multimedia content such as audio or video or graphical images, multimedia advertisements or data in any encoded or binary forms. The CATS 400 fetches the content CT from the content source 10 using either a well known interface such as HTTP or any publisher defined proprietary interface. The content updates are initiated either by the CATS 400 or by the source 10. The CATS 400 processes the content, transforms the content for passive usage and stores the metadata (MD) describing the transformed content such as URLs, creation time, markers for content augmentation etc., into a database. The CATS 400 updates the CoRDS 200 with the meta-data of the adapted content. The meta-data synchronization between the CoRDS 200 and the CATS 400 is bi-directional in nature where the synchronization can be initiated by either the CATS 400 or the CoRDS 200 or both. The CATS 400 has an option to control access to the content by enforcing user authentication and authorization. The user authentication and authorization can be enforced either internally within the CATS or by communicating with an external authentication engine 20. The CATS 400 periodically synchronizes with the CoRDS 200 to get accounting, auditing and control information such as usage, listening and advertisement statistics. The CATS 400 also receives similar audit accounting and control information from the client device agent (CDA) 515. The CATS 400 provides the usage, stats, accounting and tracking information back to the publisher audit entity 30.

Illustrated in FIG. 1, The CoRDS 200 is a central repository of meta-data that describes the transformed content available from various publishers. It processes and organizes the content meta-data using factors like categories, relevancy. The CoRDS 200 interfaces with an auxiliary data feeder 40 to get auxiliary data that is of interest to an end-consumer such as deals, traffic, advertisements etc. The CoRDS 200 acts as an intelligent gateway between the adapted content and the users—It enables client devices 500 to fetch the compiled content information lists (CCIL) based on relevancy, categories etc. The capabilities and preferences of the client device (CCCD) 500 are tracked by the CoRDS 200 system. The CoRDS 200 receives content requests from client device agent CDA 515 and responds with a Compiled Content Information List (CCIL) for the requested categories of content and auxiliary data. The communication between the client device agent (CDA) 515 and the CoRDS 200 can be either a push model or a pull model. In the push model, the CoRDS 200 detects the availability of updated content and notifies the CDA 515. In the pull model the CoRDS 200 receives a request from the CDA 515 and responds back with the information requested. The CoRDS 200 collects statistics such as usage, accounting and auditing information from the CDA 515. The CoRDS 200 also synchronizes such auditing information back to the related publisher's CATS 400. The CoRDS 200 can also provide content consumption trends to other third parties 50 interested in such information.

As shown in FIG. 1, the content consuming client device (CCCD) 500 facilitates an end user to consume the content. The nature and capabilities of these devices vary—for e.g. it could be a portable hand held smart device, a personal laptop, a general purpose computer or a specialized piece of hardware with capabilities for the adapted content usage as mentioned in this application. The client device agent (CDA) 515, resident on the client device (CCCD) 500 will adjust and utilize such capabilities to enable the content consumption. The client device agent 515 will contact the CoRDS 200 to get a compiled content information list (CCIL). The CDA 515 makes use of the CCIL, user preferences, other CCCD 500 based capabilities and other navigational input from the user to contact the appropriate CATS 400 for fetching the actual adapted content. The CATS 400 will respond back with the requested adapted content. The client device agent (CDA) 515, utilizing the device capabilities such as the OS and the hardware, plays the content for user consumption. The CDA 515 offers user friendly interface for interactive browsing and browse-free listening modes.

Content augmentation with auxiliary content could happen hierarchically at the multiple stages of the system—the main content originator ‘the publisher’, the ‘content aggregator and organizer’ and the end content consuming client. The system provides flexibility to honor or override the auxiliary content based on the underlying contractual arrangements.

### Content Routing and Directory Server—CoRDS 200

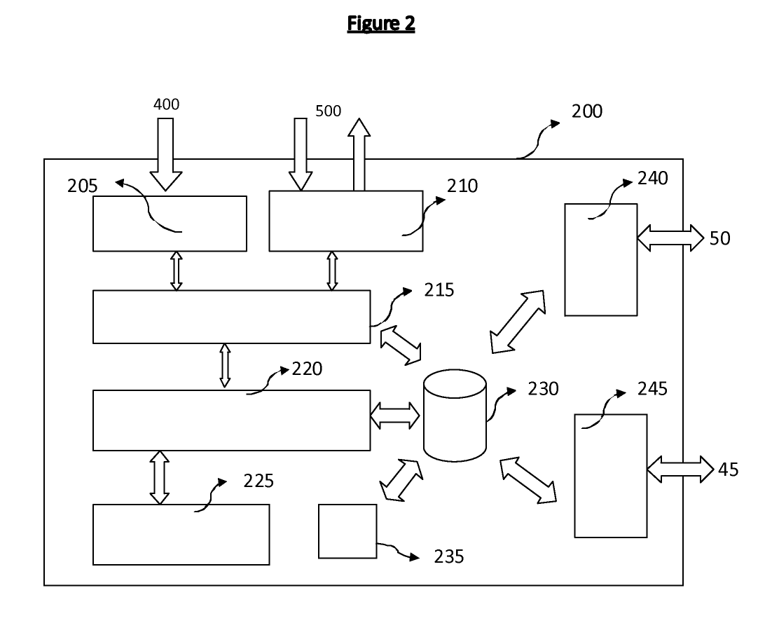

FIG. 2 depicts the functional blocks of the Content Routing and Directory Server—CoRDS 200. The CoRDS 200 maintains the metadata about the available adapted content. It does not necessarily host any content. However it tracks the content urls from the configured/listed sources and their relevancy to a user.

The CoRDS 200 has a Metadata Synchronization Module (MSM) 205 that synchronizes periodically with the CATS 400 to refresh the main and auxiliary content timestamps, urls, categories, advertisement categories etc. It receives request for content from the CDA 515 and processes requests through the User Request Processor (URP) 210. The CoRDS 200 has Directory Service 215 that maps available sources to given content categories. 220 is a Relevancy Processor (RP) responsible for applying the relevancy rules to serve applicable content from the set of available adapted content. Some example relevancy rules are: age of the content, client device capabilities, user preferences for information sources, preferences for relevant references and other auxiliary content. 225 is an Auxiliary Content and CCIL generator that acts as a mixer for the content. The main content is interleaved with the auxiliary content like advertisements (text, graphics or multimedia), references and other promotional material. Various user preferences, location identifiers, demographic information could be used in serving the relevant auxiliary content. The final CCIL is then delivered as a response to the request from CDA 515. The CoRDS 200 has a user preferences and a content metadata database (UCMDB) 230. The database stores the user preferences with regards to the content, user device capabilities, content consumption history etc. for each user. The content metadata like original timestamps, content markers for auxiliary content insertion, relevant references etc are also stored in different tables of the database.

The user related statistics are aggregated by the (USG) 235.

240 is a user data mining module (UDM) that is responsible for exporting user content usage history to the content publishers.

245 is an Advertisement Usage Reconciliation Module (AURM) that is responsible for reconciling advertisement statistics back to the advertisement campaigners.

### Text to Speech Module—TSM 300

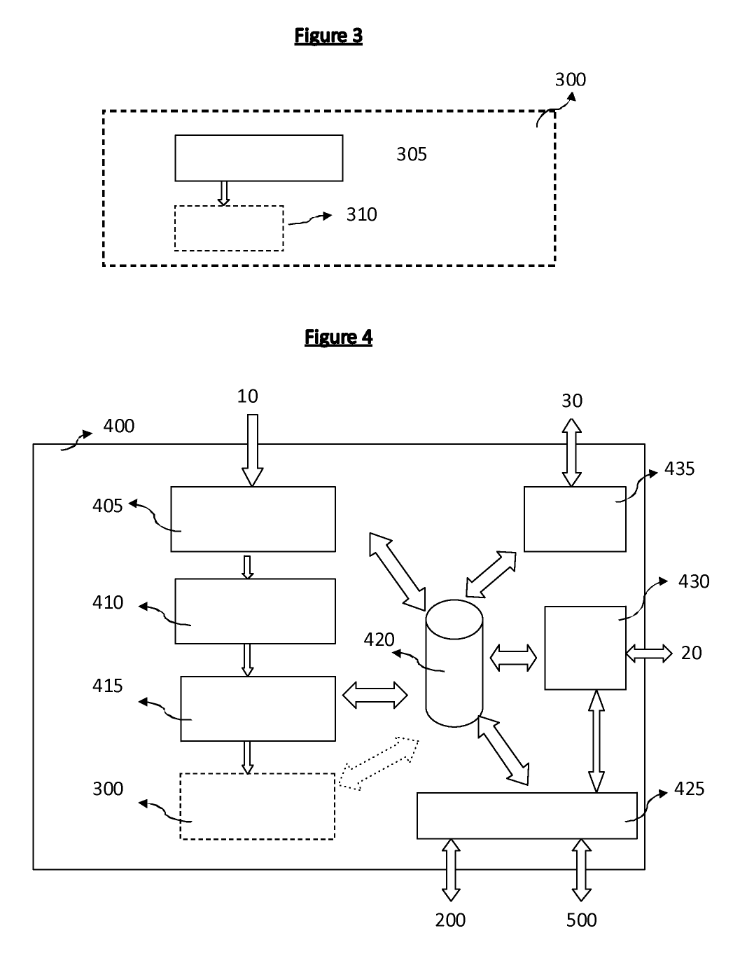

FIG. 3 shows the functional blocks of a Text to Speech Module (TSM) 300. The TSM 300 facilitates the conversion of main and any auxiliary textual content into audio form. This enables the end user to listen to the audio-transformed content with minimal interaction as compared to reading the original form. The TSM has Text to Speech Generator (TSG) that uses a host of language processing and speech synthesizing techniques to generate the audio wave form. There is an optional audio encoding module 310 that is responsible for digital encoding and compression of the audio into one or more of the supported codec formats like mp3, AAC etc. The TSM 300 can be located in one or more places in the system. If the client device has sufficient processing power, it is preferred to place TSM 300 in the client device (CCCD 500). This would eliminate the storage and transmission requirements of the audio over the network. In such a scenario 310 would be completely optional.

### Content Adaptation and Transformation Server—CATS 400

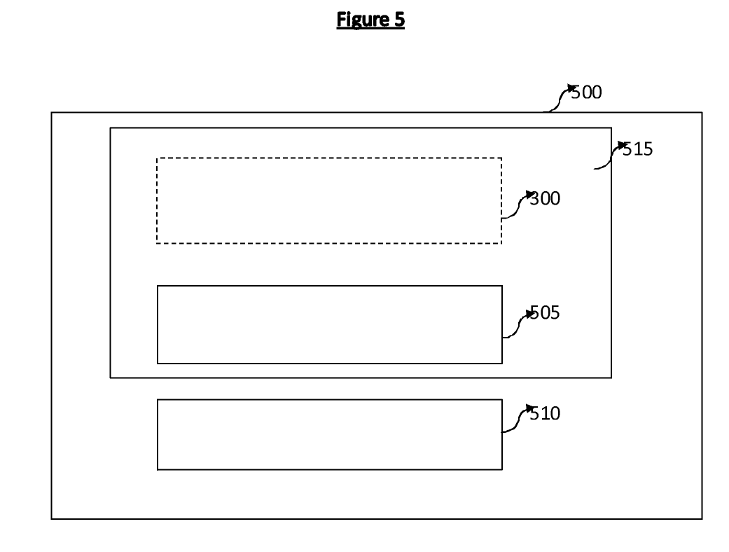

FIG. 4 shows the functional blocks of a Content Adaptation and Transformation Server (CATS) 400. The CATS 400 is responsible for adapting the content into a form suitable for minimally interactive consumption. The CATS 400 has Preprocessing and Categorization Module (CM) 405. CM is responsible for processing the published content from contents sources 10 (typically from websites and blogs) and categorizes it into various categories like news, sports, finance news etc.

The content is then transformed (adapted) by the Content Adapter (CA) 410. Transformations in this layer include summarization of the content into a shorter form (less words), translating from one language to another etc.

415 is a Content Augmentation Processor (CAP). CAP 415 takes the adapted content generated by 410 and identifies locations where the auxiliary content can be inserted. Examples of auxiliary content include: advertisements (textual, graphical, multi-media . . . ), promotional material, traffic reports etc. The output of CAP 415 is the final adapted content with markers for additional content insertion. The actual insertion could also happen at other stages in the system. CoRDS 200 and CDA 515 are the potential places where additional auxiliary content could be inserted. This would enable the system to target the users better with relevant auxiliary information.

The Text to Speech Module (TSM) 300 is an optional module in CATS 400. It enables the CATS 400 to convert the text to audio and serve the audio directly to requestors.

420 is the content database. The adapted content with augmentation markers is stored here. If the optional TSM 300 is present the generated audio is also stored in the database. 425 is the content serving module (CSM). The CSM 425 handles requests for content from CDA 515 and request for content meta-data (MD) from CoRDS 200 and serves the requested information. The CSM 425 accesses the content to be served from the content database 420. The CSM 425 has an option to authenticate and authorize access to the content by interfacing with an authentication and authorization module (AAM) 430. The AAM 430 can be implemented completely internal to the CATS 400 or it can communicate with an external authentication mechanism 20.

435 is an Audit and Statistics Module (ASM). The ASM 435 keeps track of the statistics and audit information such as what content is served, how many accesses , and who accessed, what auxiliary content (such as advertisements etc.) is served and makes this information available to any publisher audit entity 30.

### Content Consuming Client Device—CCCD 500

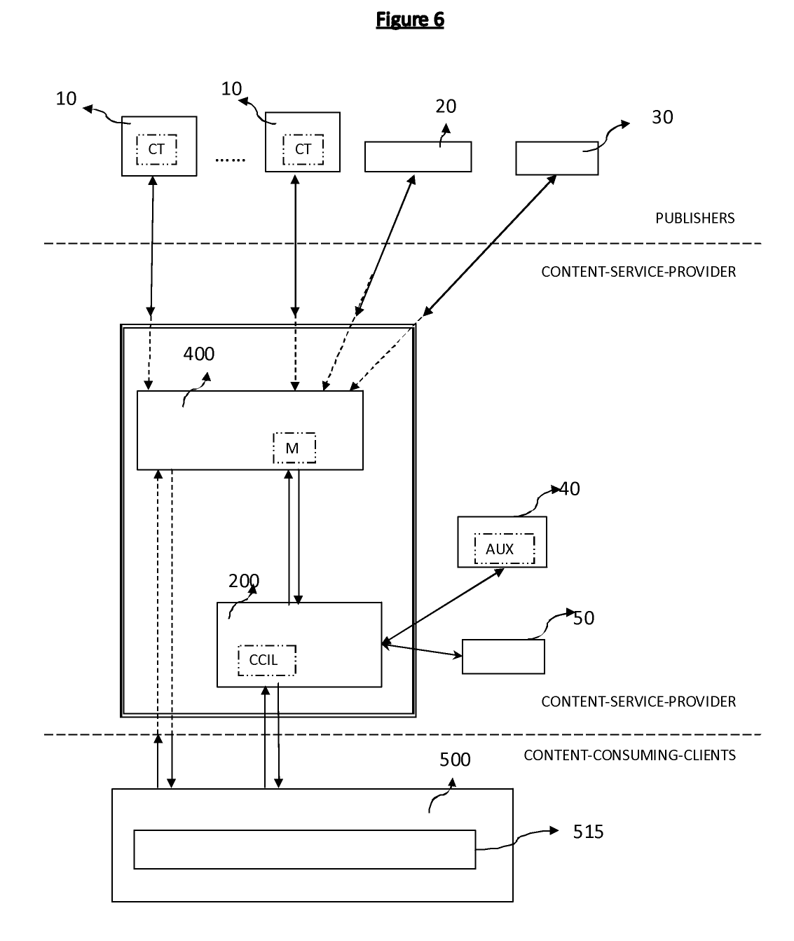

FIG. 5 is a representation of the Content Consuming Client Device (CCCD). The key component of the CCCD 500 is the Client Device Agent (CDA) 515. The content processing and presentation capabilities of the client devices may vary widely. The CDA inside the Client Device is responsible to choose the appropriate capabilities and offer optimal user experience of the adapted content.

505 is a key software component responsible for making requests to the CATS 400 and the CoRDS 200. It is capable of inserting additional content based on context and relevancy such as location based traffic and weather reports, calendar notifications etc. It offers the user interface functionality to present the final content.

510 is the base Operating System layer. It provides the necessary services for connectivity, task and application management. Examples of this could include: iOS for iPhone, Android or any other platform operating system.

300 is an optional module in the Client Device Agent. It is preferable to have the Text to Speech Module inside the CDA if the CCCD 500 is capable of performing the task. This is very effective in saving the network bandwidth requirements for both client (CCCD 500) and the server (CATS 400).

### Alternative Deployment Scenarios

FIG. 6 shows an example deployment variation of the same system architecture as shown in FIG. 1. The deployment scenario has the same components as in FIG. 1 and the deployment variation is purely a matter of logistics on part of the players involved. When it is not feasible to have a CATS 400 at a publisher's site, it is possible to have a scenario where an “application service provider” more specifically a “content-service-provider” can host the CATS 400 server along side with the CoRDS 200. Such “content-service-providers” typically serve several publishers. The architecture and the data flow and the functional components remain the same as explained earlier in the context of FIGS. 1-5.

It is possible that the CoRDS 200 and CATS 400 are physically either co-located or not co-located, but they are managed and co-hosted typically by the same “content-service-provider”. It is also possible that there can be “content-service-providers” that only specialize in hosting CATS 400 working with some other “content-service-provider” hosting the CoRDS 200 server. Whatever the business logistics drive at, the underlying functional components and the data flow remain the same as in described in FIGS. 1-5.

Also from a scalability perspective and fault tolerance there could be more than one instance of the CATS 400 and CoRDS 200 components distributing the load in terms of publishers as well as clients but the overall system data flow and functional distribution remains the same as described in FIG. 1-5.

1. A method of multi-tier adaptation & augmentation of content, its distribution and presentation for passive and minimally interactive consumption.

2. A method as claimed in 1, that can optionally preserve subscription, copyright and restricted access to meet the specific needs of content publishers and enterprises.

3. A method as claimed in 1, where in using an appliance(s) embodying the said frameworks as claimed in 1, that are installed and operated at the content publishers premises enabling the publisher to leverage the content adaptation and distribution mechanisms and giving the publisher complete control of the system.

4. A method as claimed in 1 and 2, that enables a publisher to leverage the content adaptation and distribution system with the service operated by a third party service provider.

5. A method as claimed in 1-4 that enables the distribution of the content to end user devices in an on-demand or automated manner.

6. A method as claimed in 5, where the end devices can access the content either online with established connectivity to the system or in a ‘sync and go’ for offline consumption.

7. A method as claimed in 1-5 with the ability to the publisher to get statistics and reports enabling the tracking and control of the publisher's content adaptation, distribution.

8. A method as claimed in 1-5 with the ability to track the user usage, content effectiveness, user attention to the content and consumption trends.

9. A method as claimed in 1-5, that enables content adaptation, augmentation, customization to take place at multiple levels in the tiered architecture.

10. A method as claimed in 1-5, that uses adaptive and smart techniques to enhance user experience in organizing and consuming the content

11. A method as claimed in 1-5,9,10, that provides consumer friendly content presentation, adapting to the content consumer's preferences as well as dynamic contextual inputs leveraged from available inputs.

12. A method as claimed in 1-5,9,10, with the content presentation style and features are fine tuned to minimize user interaction and facilitate passive usage.
